(19) United States
(12) Patent Application Publication
(10) Pub. No.: US 2012/0187902 A1
(43) Pub. Date: Jul. 26, 2012

(54) Portable battery charger

(76) Inventor: Wen Fee Wang, Las Vegas, NV (US)

(21) Appl. No.: 13/374,663

(22) Filed: Jan. 5, 2012

Related U.S. Application Data
(60) Provisional application No. 61/460,698, filed on Jan. 6, 2011.

(51) Int. Cl. H02J 7/00

(52) U.S. Cl. 320/107

(57) ABSTRACT

A portable battery charger has a built-in, retractable connector for charging a portable electronic device. In a first position, a first connector is exposed to the outside of the portable battery charger, to be inserted into a power supply apparatus for charging a reserve battery in the portable battery charger. In a second position, a second connector is exposed to the outside of the portable battery charger, to be inserted into a portable electronic device for charging the portable electronic device. In a third position, both the first and second connectors are covered in the case of the portable battery charger.

### CROSS REFERENCE

This application claims the benefit of U.S. Provisional Patent Application No. 61/460,698, filed Jan. 6, 2011.

### BACKGROUND OF THE INVENTION

The present invention relates generally to a portable battery charger and, more particularly, to a portable battery charger with at least one retractable connector.

Portable electronic devices have become an important and indispensible gadget for many people in their lives. There are many types of portable electronic devices, such as smart phones, mobile phones, cellular phones, satellite phones, MP3 players, portable DVD players, digital cameras, tablet computers, global positioning systems, portable game consoles, and other portable devices capable of processing digital information. As those portable electronic devices evolve, they become increasingly complicated in design, and therefore consume more power. As a result, it is desired that the portable electronic device is equipped with a battery that is able to power the device for a long time.

However, the original battery of the portable electronic device is often limited in its capacity, and therefore not able to power the device for as a long time as a user may desire. This can make the experience of using the portable electronic device frustrating. For example, as a user is watching a movie on his smart phone, he may become frustrated if the movie is cut short due to insufficient amount of battery time. One solution to keep the portable electronic device running for a long time is for a user to carry a portable battery charger that can charge the original battery of the portable electronic device whenever and wherever it is needed.

FIG. 1 illustrates a schematic, top view of a conventional portable battery charger 10 for charging a portable electronic device 20, such as a smart phone. Inside the portable battery charger 10, there is a reserve battery (not shown in the figure) functioning as a back-up power supply for the portable electronic device 20. Typically, there is a control circuitry in the portable battery charger 10 for controlling the process of charging/discharging the reserve battery. The portable battery charger 10 typically includes a female USB connector 12 for receiving a male USB connector 14 of a cable 16. The male connector 18 at the other end of the cable 16 can be inserted into the portable electronic device 20. When the portable electronic device 20 and the portable battery charger 10 are connected by the cable 16, the reserve battery in the portable battery charger 10 can be activated to charge the original battery in the portable electronic device 20. The portable battery charger 10 may also include a female mini USB or micro USB connector 22 for receiving a male mini USB or micro USB connector 24 of a cable 26. The other end of the cable 26 can be plugged into a power supply apparatus. When the power cable 26 connects the portable battery charger 10 to the power supply apparatus, the reserve battery in the portable battery charger 10 can be recharged by the power supply apparatus.

The conventional portable battery charger 10 as illustrated in FIG. 1 has certain shortcomings. The portable battery charger 10 requires two cables 16 and 26, in order to function properly. Without the cable 16, the portable electronic device 10 would not be able to charge the portable electronic device 20. Without the cable 26, the reserve battery of the portable battery charger 10 cannot be recharged. This makes the portable battery charger inconvenient to use. For example, when a person travels, he needs to carry two cables for the portable battery charger in addition to his other cables required by other devices. Sometimes, these cables can tangle, thereby making the user experience unpleasant. Moreover, if any of the cables 16 and 26 is lost, he will need to repurchase it, thereby incurring additional costs.

The portable battery charger 10 can be bulky and inconvenient to carry around. The size of the portable battery charger 10 can be similar to that of the portable electronic device 20. It can be quite uncomfortable for a person to carry both of them in his pockets, let along the necessary cables 16 and 26 in order for the portable battery charger 10 to function properly.

FIG. 2 illustrates a schematic, top view of another conventional portable battery charger 50 for charging a portable electronic device 40, such as a smart phone. Inside the portable battery charger 50 there is a reserve battery (not shown in the figure). Typically, there is a control circuitry in the portable battery charger 50 for controlling the process of charging/discharging the reserve battery. The portable battery charger 50 has a male connector 52 compatible with a female connector 42 of the portable electronic device 40. When the male connector 52 is plugged into the female connector 42, the reserve battery of the portable battery charger 50 can charge the original battery of the portable electronic device 40, either automatically or upon initiation by a user. The portable battery charger 50 may also include a female mini USB or micro USB connector 54 for receiving a male mini USB or micro USB connector 56 of a cable 58. The other end of the cable 58 can be plugged into a power supply apparatus. When the cable 58 connects the portable battery charger 50 to the power supply apparatus, the reserve battery in the portable battery charger 50 can be recharged by the power supply apparatus.

Although the portable battery charger 50 is smaller in size than the portable battery charger 10, the male connector 52 thereof is susceptible to damages. The male connector 52 is typically constructed by a thin metal case surrounding a fragile printed circuit board (not shown in the figure). As shown in FIG. 2, the male connector 52 is exposed to the outside of the portable battery charger 50, and therefore can be easily or accidentally damaged by an impact of external force. In addition, since the portable battery charger 50 still requires a cable 58, it can still be inconvenient to use and carry around.

As such, what is needed is a portable battery charger for a portable electronic device that is compact, reliable, and easy to carry around in a manner that provides pleasant and superior product experiences for users.

### BRIEF SUMMARY OF THE INVENTION

The present invention is directed to a portable battery charger for charging a portable electronic device. In some embodiments of the invention, the portable battery charger includes a case having a first opening and a second opening; a connector body having a first connector and a second connector adapted to move in the case among a first position where the first connector is exposed to an outside of the case through the first opening and the second connector is covered by the case, a second position where the second connector is exposed to an outside of the case through the second opening and the first connector is covered by the case, and a third position where both the first and second connectors are covered by the case; a first printed circuit board being placed in the connector body, and having a first set of conductors functioning as electrical contact areas of the first connector and a second set of conductors functioning as electrical contact areas of the second connector; a second printed circuit board having a set of conductive strips electrically connected to the first and second sets of conductors via an interconnection structure; and a reserve battery electrically connected to selected ones of conductive strips, such that when the connector body is in the first position, the first connector is adapted to receive power for charging the reserve battery, and when the connector body is in the second position, the second connector is adapted to be inserted into the portable electronic device for charging a original battery thereof.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 illustrates a schematic, top view of a conventional portable battery charger for charging a portable electronic device.

FIG. 2 illustrates a schematic, top view of another conventional portable battery charger for charging a portable electronic device.

FIG. 3 illustrates a perspective view of a portable battery charger in accordance with some embodiments of the invention.

FIG. 4 illustrates a perspective view of a portable battery charger for charging a portable electronic device in accordance with some embodiments of the invention.

FIG. 5A illustrates a top view of a portable battery charger for connecting with a portable electronic device in accordance with some embodiments of the invention.

FIG. 5B illustrates a side view of a portable battery charger connected with a portable electronic device in accordance with some embodiments of the invention.

FIG. 6 illustrates a top view of a portable battery charger with its upper case removed in accordance with some embodiments of the invention.

FIG. 7 illustrates a first printed circuit board of the portable battery charger in accordance with some embodiments of the invention.

FIG. 8 illustrates a second printed circuit board of the portable battery charger in accordance with some embodiments of the invention.

FIG. 9 illustrates a cross-sectional view of the portable battery charger with its upper case removed in accordance with some embodiments of the invention.

FIG. 10 illustrates a top view of an interconnection structure of the portable battery charger in accordance with some embodiments of the invention.

FIG. 11 illustrates a perspective view of the interconnection structure of the portable battery charger in accordance with some embodiments of the invention.

FIG. 12 illustrates a block diagram of the portable battery charger in accordance with some embodiments of the invention.

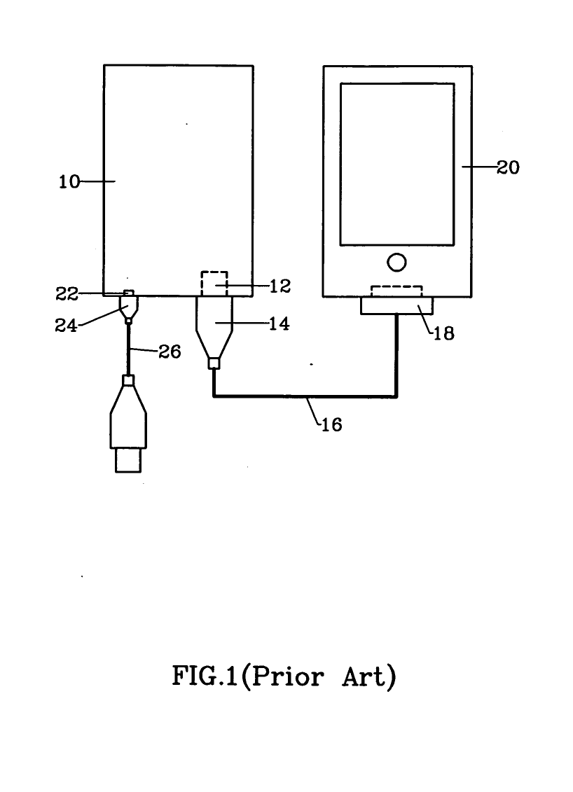

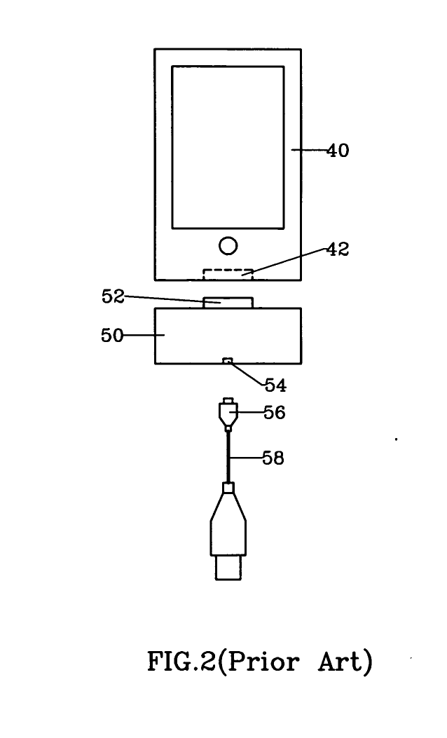

### DETAILED DESCRIPTION OF THE INVENTION

The present invention is directed to a portable battery charger having a retractable connector body that can be slid into and out of a case of the portable battery charger. The connector body has a first connector compatible with a female connector of a power supply apparatus, such as power outlets on the wall, power outlets in motor vehicles, computers, and other electronic devices. The connector body has a second connector compatible with a female connector of a portable electronic device, such as smart phones, mobile phones, cellular phones, satellite phones, MP3 players, portable DVD players, digital cameras, tablet computers, global positioning systems, portable game consoles, and other portable devices capable of processing digital information. The connector body can move into a number of positions. In the first position, the first connector is exposed to the outside of the case of the portable battery charger while the second connector is covered inside, such that the first connector can be plugged into the power supply apparatus for charging a reserve battery in the portable battery charger. In the second position, the second connector is exposed to the outside of the case of the portable battery charger while the first connector is covered inside, such that the second connector can be inserted into the portable electronic device to charge an original battery therein with the reserve battery. In the third position, both the first and second connectors are fully covered by the case of the portable battery charger, such that they can be protected from damages caused by external forces. Embodiments of the present invention will be described below in greater details with reference to accompanying drawings.

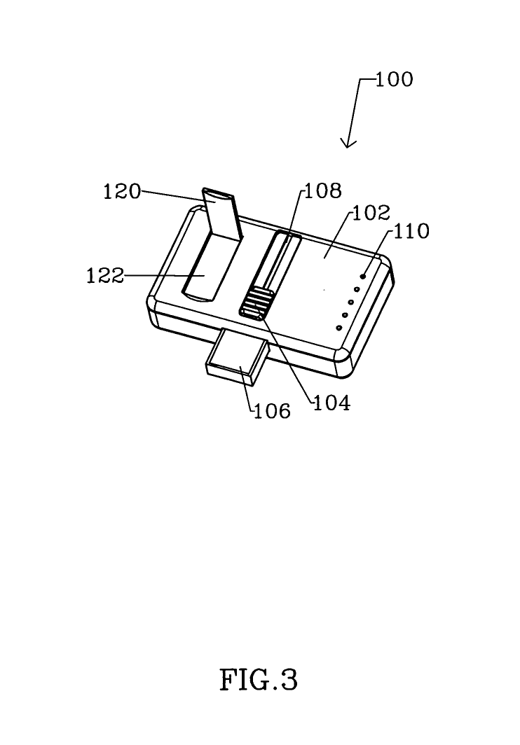

FIG. 3 illustrates a perspective view of a portable battery charger 100 for charging a portable electronic device in accordance with some embodiments of the invention. The portable battery charger 100 includes a case 102 containing various components, which cannot be clearly seen in this figure but will be described with reference to other drawings. Among those components, there is a connector body have a first connector and a second connector that can be moved among the first, second, and third positions. The connector body can be moved in a transverse direction of the case 102 by manually pushing a tab 104 attached to the connector body. In FIG. 3, the tab 104 is pushed to the left end of a groove 108, such that the connector body is disposed in the first position where the first connector 106 is exposed to the outside of the case 102 through an opening. The exposed first connector 106 can be plugged into a power supply apparatus for charging a reserve battery in the case 102.

In some embodiments of the invention, the first connector 106 can be a male USB connector compatible with a USB port embedded in a computer, other electronic devices, or any adapters connecting the USB connector to a power outlet on the wall or in a motor vehicle. In other embodiments of the invention, the first connector 106 can be male mini USB or micro USB connector compatible with a female mini USB or micro USB connector embedded in a computer, other electronic devices, or any adapters connecting the mini USB or micro USB connector to a power outlet on the wall or in a motor vehicle.

A number of indicator lights 110 are visible on a surface of the case 102 for indicating a current capacity of the reserve battery in the case 102. For example, in the embodiment of the invention illustrated by FIG. 3, there are five indicator lights 110 on the top surface of the case 102. When all of the five indicator lights 110 are on, it indicates that the current capacity of the reserve battery is nearly full. When only three of the five indicator lights 110 are on and the other two are off, it indicates that the reserve battery has power about 60 percent of the full capacity. Of course, the number of indicator lights is not limited to five only, and can be more or fewer than five, depending on deign choices.

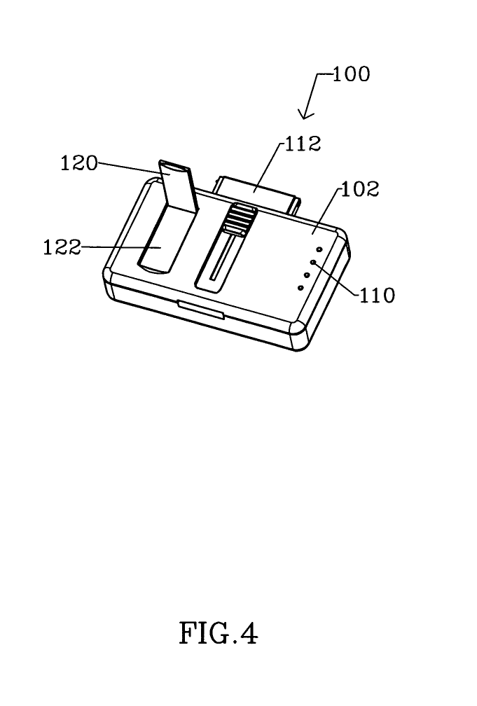

The indicator lights 110 can be triggered by various methods. For example, in some embodiments of the invention, the indicator lights 110 are triggered, when the connector body is in the first position, where the first connector 106 is fully exposed to the outside of the case 102, and the first connector 106 is plugged into the power supply apparatus. In some other embodiments of the invention, the indicator are triggered, when the connector body is in the second position as shown in FIG. 4, where the second connector 112 is fully exposed to the outside of the case 102, and the second connector 112 is inserted into the portable electronic device. In yet some other embodiments of the invention, the indicator lights 110 can be triggered by other methods. Details of such embodiments will be described further below with reference to other drawings.

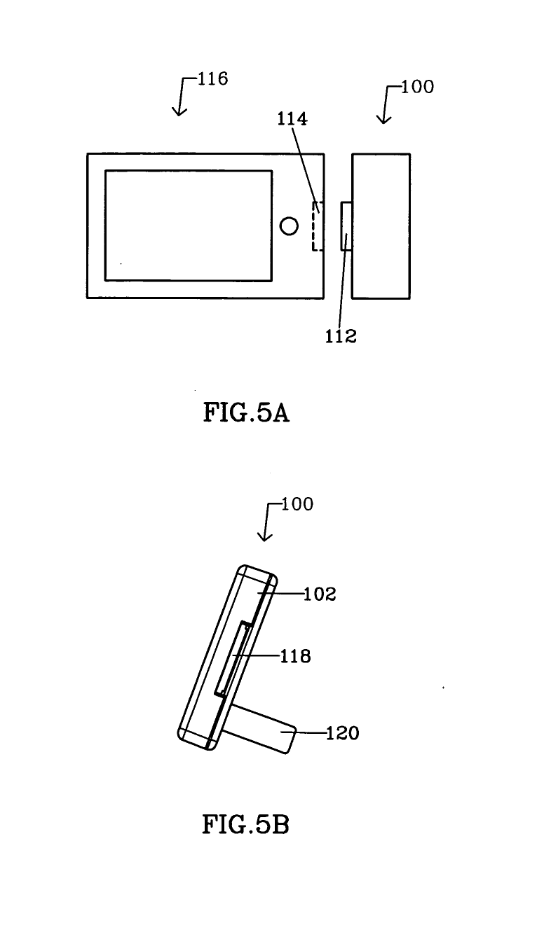

As shown in FIG. 4, the connector body is in a second position where the second connector 112 is exposed to the outside of the case 102, whereas the first connector 106 is retracted into the case 102 and not visible from the outside. The second connector 112 can be inserted into a compatible female connector 114 embedded in a portable electronic device 116, as shown in FIG. 5A. When the second connector 112 is inserted into the female connector 114 of the portable electronic device 116, if the reserve battery in the portable battery charger 100 has sufficient power, it will charge an original battery (not shown in the figure) in the portable electronic device 116.

In some embodiments of the invention, the portable electronic device can be a smart phone, such as iPhones designed by Apple, Inc., a company having a principle place of business in California, the United States of America. In such case, the second connector 112 is compatible with the female connector embedded in the iPhone. The iPhone connector is proprietarily designed by Apple, Inc., and typically has thirty pins for carrying out various functions. The second connector 112 is physically compatible with the iPhone connector, such that it can be inserted in it and form a tight connection. However, the number of pins in the second connector 112 can be reduced as long as it serves the function of delivering electric power from the reserve battery in the portable battery charger 100 to the original battery in the iPhone. In some other embodiments of the invention, the portable electronic device 116 can be other types of smart phones, such as the ones produced by HTC, Samsung, Research In Motion, and other smart phone makers, or other electronic devices. In such cases, the second connector 112 can be a micro USB connector or a mini USB connector.

FIG. 5B illustrates a side view of the portable battery charger 100 connected with the portable electronic device 116. An opening 118 for enabling the first connector 106 to move in and out of the case 102 of the portable battery charger 100 is visible. Due to the angle of the view, the second connector 112 and the portable electronic device 116 are not visible. This figure shows a foldable stand 120 in an extended position, such that the portable battery charger 100 and the portable electronic device 116 can stand on a surface, thereby enhancing certain functionalities of the portable electronic device 116. For example, the standing feature enhances the video playing function of the portable electronic device 116 by eliminating the need for a user to hold the portable electronic device 116 through out the time of video playing. As more clearly illustrated in FIGS. 3 and 4, the foldable stand 120 can be folded on to a recessed area 122 on the surface of the case 102. When the foldable stand 120 rests on the recess area 122, the portable battery charger 100 takes less space and becomes easy to be carried around by users.

In an alternative embodiment of the invention, the foldable stand 120 can be eliminated altogether, thereby enabling the case 102 to be made thinner and lighter than one with the foldable stand 120 attached to it. It is therefore understood that the foldable stand 120 is an optional design that can be selectively implemented or eliminated within the scope of the present invention.

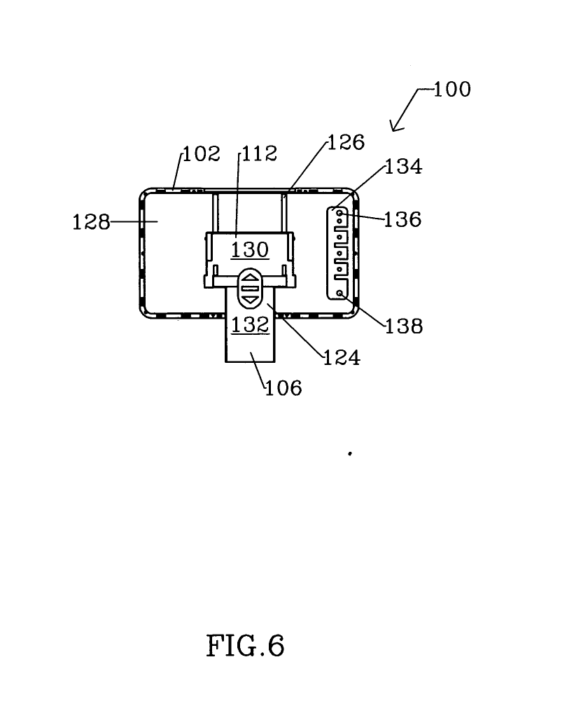

FIG. 6 illustrates a top view of the portable battery charger 100 with its upper case removed in accordance with some embodiments of the invention. The connector body 124 has the first connector 106 at one end and the second connector 112 at the other. A first printed circuit board (not visible in this figure) is enclosed in the connector body 124 by a first cover 130 and a second cover 132. A pair of tracks 126 is provided on a surface of a second printed circuit board 128. The connector body 124 is configured so that it can move back and forth on the tracks 126. FIG. 6 shows that the connector body 124 is moved to the bottom of the tracks 126 into the first position where the first connector 106 is exposed to the outside of the case 102 though an opening, while the second connector 112 is covered inside the case 102. Although it is not explicitly depicted in this figure, the connector body 124 can be moved to the top of the tracks 126 into the second position where the second connector 112 is exposed to the outside of the case 102 through an opening, while the first connector 106 is covered inside the case 102. The connector body 124 can also be moved to the middle of the tracks 126 into the third position where both the first and second connectors 106 and 112 are fully covered inside the case 102, without being exposed to the outside.

In some embodiments of the invention, a cover sheet 134 can be placed on top of a number of LEDs (light emitting diodes) embedded on the second printed circuit board 128 to form the indicator lights 110 as illustrated in FIGS. 3 and 4. The cover sheet 134 includes a number of openings through which the LEDs are visible from the outside of the case 102. The cover sheet 134 can also include a number of screw holes 138, such that screws can be used to secure the cover sheet 134 on to the second printed circuit board 128.

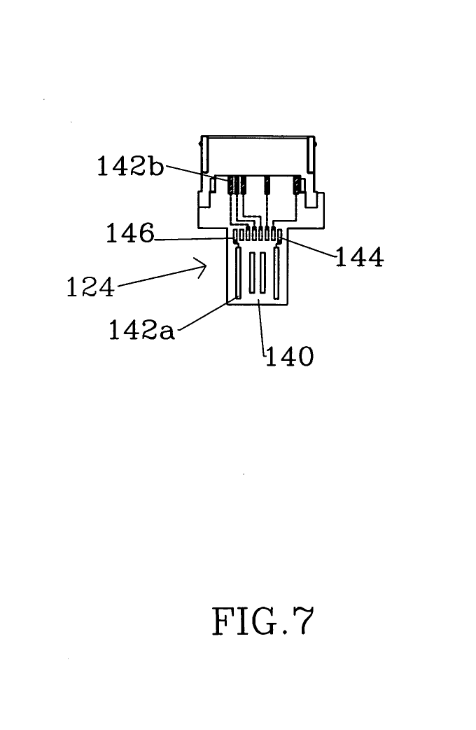

FIG. 7 illustrates a top view of the connector body 124 with the second cover 132 removed in accordance with some embodiments of the invention. The first printed circuit board 140 is visible in this figure. The first printed circuit board 140 is shaped like the letter T. On the first printed circuit board 140, a number of conductors are constructed. The conductors can be categorized into a first set of conductors 142a placed at the narrow end of the T-shaped first printed circuit board 140, and a second set of conductors 142b placed at the wide end of the T-shaped first printed circuit board 140. The first and second sets of conductors 142a and 142b are disposed on the same surface of the first printed circuit board 140, which is the top surface according to the viewing angle of this figure. The first set of conductors 142a are arranged in a manner, such that they are corresponding to the power pins of the female connector of the power supply apparatus. The second set of conductors 142b are arranged in a manner, such that they are corresponding to the power pins of the female connector of the portable electronic device.

On another surface of the first printed circuit board 140, a number of conductive pads 144 are constructed. The surface on which the conductive pads 144 are formed is opposite to the surface on which the first and second sets of conductors 142a and 142b are formed. In FIG. 7, the conductive pads 144 are illustrated in dotted lines to indicate that they are constructed on the bottom surface of the first printed circuit board 140, and thereby cannot be readily seen from the viewing angle of the drawing. Each of the first set of conductors 142a is electrically connected to its corresponding conductive pad 144 via a corresponding conductive bridge 145, which extends through the first printed circuit board 140 in a direction normal to its surfaces. Likewise, each of the second set of conductors 142b is electrically connected to its corresponding conductive pad 144 via a corresponding conductive bridge 145, which extends through the first printed circuit board 140 in a direction normal to its surfaces.

It is noted that although a total number of eight conductors are illustrated in FIG. 7, in some embodiments of the invention, it may be more or fewer than eight depending on the layouts of the pins in the corresponding female connectors. It is also noted that, in some embodiments of the invention, each of the conductive bridges 145 and its corresponding conductive pad 144 can be merged into a larger conductive bridge in a size similar to that of the conductive pad 144. In such case, the conductive pads 144 are effectively replaced by enlarged conductive bridges 145 extending through the first printed circuit board 140 in a direction normal to its surfaces.

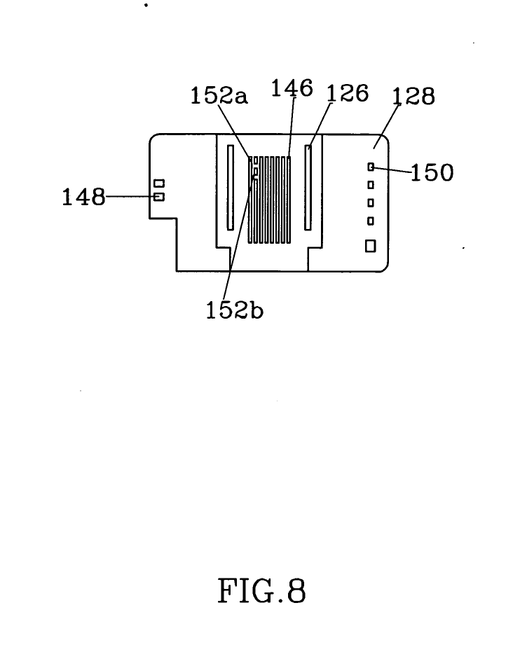

FIG. 8 illustrates a top view of the second printed circuit board 128 in accordance with some embodiments of the invention. On a surface of the second printed circuit board 128, a number of conductive strips 146 are constructed, each of which corresponds to each of the conductive pads 144 illustrated in FIG. 7. An interconnection structure (not shown in this figure) is placed between the first and second printed boards 140 and 128 for electrically connecting each of the conductors 142a and 142b to the a corresponding one of the conductive strips 146 via the corresponding conductive bridge 145 and pad 144.

The second printed circuit board 128 includes a pair of conductive joints 148, one being connected to the positive electrode of the reserve battery (not shown in the figure), and the other being connected to the negative electrode of the same. The conductive joints 148 are constructed on a surface of the second printed board 128 opposite to the surface on which the conductive strips are constructed. The conductive joints 148 are connected to a number of the conductive strips 146 via conductive lines embedded on the second printed circuit board 128, such that some of the conductive strips 146 are connected to the positive electrode of the reserve battery, and some others of the conductive strips are connected to the negative electrode of the same. As discussed above, the interconnection structure, which will be described in detail below, electrically connects each of the conductive strips 146 to its corresponding one of the conductors 142a and 142b via the conductive pads 144 and bridges 145. Such interconnection is configured in a manner such that at least one of the first set of conductors 142a is electrically connected to the positive electrode of the reserve battery, and another to the negative electrode thereof, whereas at least one of the second set of the conductors 142b is electrically connected to the positive electrode and another to the negative electrode. Thus, when the first connector 106 is plugged into a power supply apparatus, the first set of conductors 142a, conductive bridges 145, conductive pads 144, interconnection structure, conductive strips 146, conductive lines embedded on the second printed circuit board 128, and conductive joints 148 collectively provides an electric path for the power supply apparatus to charge the reserve battery in the portable battery charger. Likewise, when the second connector 112 is inserted into the portable electronic device, the second set of conductors 142b, conductive bridges 145, conductive pads 144, interconnection structure, conductive strips 146, conductive lines embedded on the second printed circuit board 128, and conductive joints 148 collectively provides an electric path for the reserve battery in the portable battery charger to charge the original battery in the portable electronic device.

A number of LEDs 150 are embedded on the surface of the second printed circuit board 128. The LEDs 150 together with the cover plate 134 form the indicator lights 110, which, when triggered, indicates the current capacity of the reserve battery. In addition to using the plugging or unplugging of the connectors to trigger the indicator lights 110, the conductive strips 146 can be used to provide a triggering signal to the LEDs 150. For example, as shown in FIG. 8, one of the conductive strips 146 is broken into two gaps 152a and 152b. The second printed circuit board 128 is configured in a manner that when the connector body 124 moves to cause a part of the interconnection structure to move across the first/second gap 152a/152b, it sends out a signal to turn on the LEDs 150, and when the connector body 124 moves to cause a part of the interconnection structure to move across the second/first gap 152b/152a, it sends out a signal to turn off the LEDs 150.

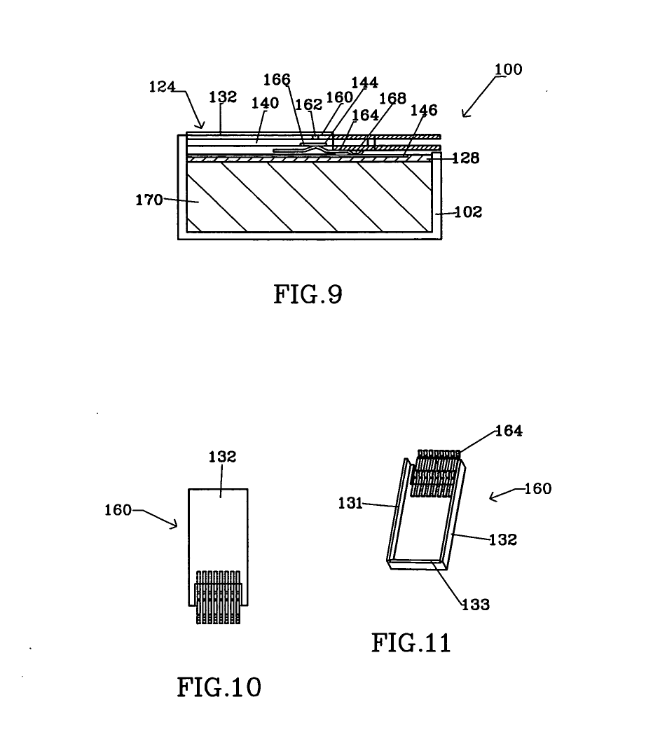

FIG. 9 illustrates a cross-sectional view of the portable battery charger 100 with the connector body 124 in the third position and the upper case of the portable battery charger 100 removed, in accordance with some embodiments of the invention. The first printed circuit board 140 is inserted into the interconnection structure 160, a top view of which is illustrated in FIG. 10, and a perspective view from the bottom of which is illustrated in FIG. 11. It is noted that the first printed circuit board 140 is not illustrated in FIGS. 10 and 11. The interconnection structure 160 includes the second cover 132 as illustrated in FIG. 6. The second cover 132 has an inwardly protruded portion 162 attached on to the first printed circuit board 140. The interconnection structure 160 includes a number of conductive fingers 164, each of which corresponds to a respective conductive pad 144 on the bottom surface of the first printed circuit board 140. Each of the conductive fingers 164 has a protruded portion 166 and a recessed portion 168. The protruded portion 166 of each of the conductive fingers 164 is soldered to its corresponding conductive pad 144 on the first printed circuit board 140, such that as the second cover 132 is pushed to move back and forth, the first printed circuit board 140 and the conductive fingers 164 move along with the second cover 132. The sidewalls 131 of the second cover 132 are slightly deeper than the back wall 133 thereof. When the second cover 132 rests on the second printed circuit board 128, the sidewalls 131 engage with the tracks 126, thereby enabling the interconnection structure 160 to move in a linear direction.

The recessed portion 168 of each of the conductive fingers 164 movably rests on its corresponding strip 146 of the second printed circuit board 128, thereby forming an electrical contact with its corresponding conductive strip 146. Thus, the conductive fingers 164 are able to electrically connect the corresponding conductive pads 144 on the first printed circuit board 140 to the corresponding conductive strips 146 on the second printed circuit board 128. A reserve battery 170 is placed under the second printed circuit board 128 in the case 102. As discussed above, the positive and negative electrodes of the reserve battery 170 are connected to a pair of conductive joint 148 on the bottom surface of the second printed circuit board 128. Thus, when the connector body 124 is in the first position, the first connector 106 exposed out of the case 102 can be plugged into the power supply apparatus for charging the reserve battery 170. When the connector body 124 is in the second position, the second connector 112 exposed out of the case 102 can be inserted into the portable electronic device for charging the original battery in the portable electronic device with the reserve battery in the portable battery charger 100. When the connector body 124 is in the third position as illustrated in FIG. 9, the first and second connectors 106 and 112 are fully covered in and protected by the case 102 of the portable battery charger 100.

Although FIGS. 7-11 illustrate embodiments of the invention where eight conductive strips 146 are used, the number of which can be more or less than eight in accommodation of various design requirements and manufacturing conditions. For example, in some other embodiments of the invention, the number of conductive strips 146 can be five, instead of eight, in order to make room for the crowded layout of the second printed circuit board 128. This can be achieved by eliminating the conductive strip having the first and second gaps 152a and 152b, as well as eliminating two conductive strips designated for ID resistors - that is the resistors designed for providing signals to identify the device connected to the portable battery charger 100. In such embodiments, the indicator lights 110 can no longer be triggered by sliding the connector body 124 across the first or second gap 152a or 152b. Thus, other methods must be employed to turn on the indicator lights 110 when needed. For example, the indicator lights 110 can be turned on simply when the first connector 106 or the second connector 112 is connected to its corresponding device. Although such embodiments might sacrifice certain functionalities, they do offer greater flexibility and simplicity in manufacturing the second printed circuit board 128.

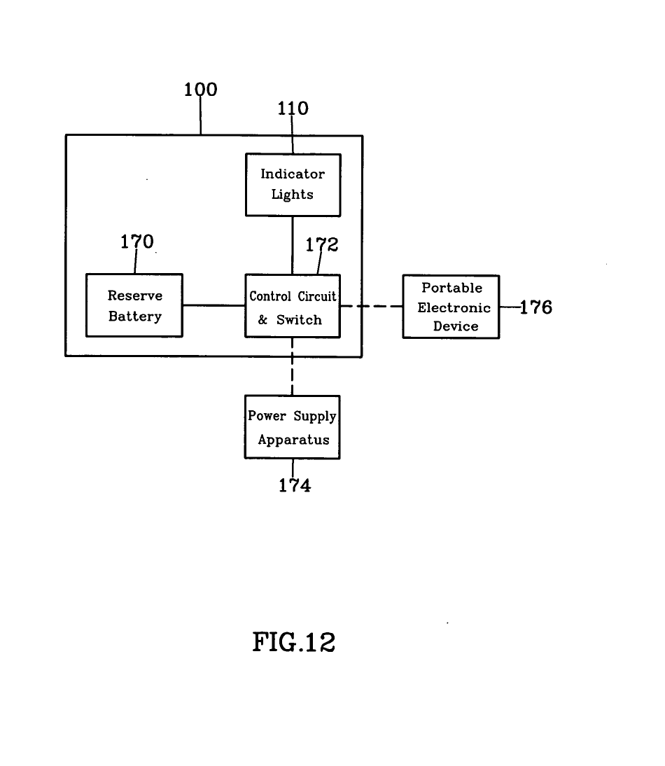

FIG. 12 illustrates a block diagram of the portable battery charger 100 in accordance with some embodiments of the invention. The portable battery charger 100 includes a control circuit and switch 172 that controls the indicator lights 110, and selectively connecting the reserve battery 170 to the power supply apparatus 174 or the portable electronic device 176. As discussed above, the control circuit and switch 172 can be configured to turn on the indicator lights 110 by a triggering signal generated in repose to the positions of the connector body 124, or whether or not the recessed portion 168 of a predetermined one of the conductive fingers 164 moves across a gap on a predetermined one of the conductive strips 146 on the second printed circuit board 128. When the first connector 106 is plugged into the power supply apparatus 174, the control circuit and switch 172 automatically detects the connection established there between, and controls the reserve battery 170 to receive power from the power supply apparatus 174 via the electrical path established between the reserve battery 170 and the power supply apparatus 174. When the second connector 112 is inserted into the portable electronic device 176, the control circuit and switch 172 automatically detects the connection established there between, and controls the reserve battery 170 to charge the portable electronic device 176 via the electrical path established between the reserve battery 170 and the original battery in the portable electronic device 176.

The portable battery charger according to the present invention provides many advantages. The portable battery charger provides the portable electronic device with a power reserve, thereby enabling a user to use the portable electronic device in a extend period of time. This feature is particularly helpful when power supply is not readily available for the user to charge the portable electronic device. For example, the portable battery charger provides the portable electronic device with a power serve, such that the user on a plane may watch a movie on the portion electronic device without any interruptions caused by insufficient battery time.

Moreover, the portable battery charger according to the invention has the connectors built in the case of the portable battery charger, thereby eliminating the need for separate cables required by the conventional battery charger to connect with the portable electronic device and power supply apparatus. This significantly enhances the user experience of the portable battery charger. For example, a user no longer needs to be worried about that he may forget to bring along the cables for the portable battery charger when traveling. This also saves the user the hassle of buying, carrying, and organizing another set of cables for the portable battery charger in addition to those required by his other electronic devices.

Furthermore, as the connectors are built in the portable battery charger, and can be fully retracted in to the case of the portable battery charger, the connectors can be well protected from damages caused by external forces. The retractable feature reduces the space required for the connectors, thereby enabling the portable battery charger to be made in a compact manner. This, in turn, enhances the appeal of the portable battery charger, and leads to greater user satisfaction and better user experience.

The above illustration provides many different embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A portable battery charger for charging a portable electronic device comprising:
a case having a first opening and a second opening;
a connector body having a first connector and a second connector adapted to move in the case among a first position where the first connector is exposed to an outside of the case through the first opening and the second connector is covered by the case, a second position where the second connector is exposed to an outside of the case through the second opening and the first connector is covered by the case, and a third position where both the first and second connectors are covered by the case;
a first printed circuit board being placed in the connector body, and having a first set of conductors functioning as electrical contact areas of the first connector and a second set of conductors functioning as electrical contact areas of the second connector;
a second printed circuit board having a set of conductive strips electrically connected to the first and second sets of conductors via an interconnection structure; and
a reserve battery electrically connected to selected ones of conductive strips, such that when the connector body is in the first position, the first connector is adapted to receive power for charging the reserve battery, and when the connector body is in the second position, the second connector is adapted to be inserted into the portable electronic device for charging a original battery thereof.

2. The portable battery charger of claim 1, wherein the first set of conductors are arranged to be compatible with a female connector of a power supply apparatus.

3. The portable battery charger of claim 1, wherein the second set of conductors are arranged to be compatible with a female connector of the portable electronic device.

4. The portable battery charger of claim 1, wherein the first printed circuit board comprises a plurality of conductive pads placed on a surface of the first printed circuit board opposite to another surface on which the first and second sets of conductors are placed.

5. The portable battery charger of claim 4, wherein each of the conductive pads is electrically connected to a corresponding one of the first and second sets of conductors.

6. The portable battery charger of claim 5, wherein the conductive pads and the first and second sets of conductors are electrically connected by a plurality of conductive bridges extending through the first printed circuit board.

7. The portable battery charger of claim 6, wherein the interconnection structure comprises a number of conductive fingers disposed between the first printed circuit board and the second printed circuit board.

8. The portable battery charger of claim 7, wherein each of the conductive fingers has a protruded portion for forming an electrical contact with a corresponding one of the conductive pads on the first printed circuit board.

9. The portable battery charger of claim 8, wherein each of the conductive fingers has a recessed portion for forming an electrical contact with a corresponding one of the conductive strips on the second printed circuit board.

10. The portable battery charger of claim 9, wherein the second printed circuit board comprises a number of indicator lights for indicating a current capacity of the reserve battery.

11. The portable battery charger of claim 10, wherein a predetermined one of the conductive strips has a first gap, and the second printed circuit board is configured in such a way that when the recessed portion of the conductive finger corresponding to the predetermined one of the conductive strips moves across the first gap, the indicator lights are triggered to indicate the current capacity of the reserve battery.

12. The portable battery charger of claim 11, wherein the predetermined one of the conductive strips has a second gap, and the second printed circuit board is configured in such a way that when the recessed portion of the conductive finger corresponding to the predetermined one of the conductive strips moves across the second gap, the indicator lights are turned off

13. The portable battery charger of claim 10, wherein the second printed circuit board is configured, so that when the first connector is plugged into a power supply apparatus, the indicator lights are triggered to indicate the current capacity of the reserve battery.

14. The portable battery charger of claim 10, wherein the second printed circuit board is configured, so that when the second connector is plugged into the portable electronic device, the indicator lights are triggered to indicate the current capacity of the reserve battery.

15. The portable battery charger of claim 1, wherein the second printed circuit board comprises at least one track on which the connector body slides.

16. The portable battery charger of claim 15, wherein the connector body has at least a sidewall configured to slide on the track.

17. The portable battery charger of claim 1, wherein the first printed circuit board is T-shaped.

18. The portable battery charger of claim 1 further comprising a foldable stand for supporting the portable batter charger and the portable electronic device in a standing position when the second connector is plugged into the portable electronic device.
